(19) United States
(12) Patent Application Publication
(10) Pub. No.: US 2014/0060277 A1
(43) Pub. Date: Mar. 6, 2014

(54) PUNCH WITH A ROTATING HEAD

(71) Applicant: Michael E. Natoli, St. Charles, MO (US)

(72) Inventor: Michael E. Natoli, St. Charles, MO (US)

(21) Appl. No.: 13/597,508

(22) Filed: Aug. 29, 2012

(51) Int. Cl. B26F 1/14

(52) U.S. Cl. 83/686

(57) ABSTRACT

A punch having a head with a stem that is received in a cavity of a holder. The stem has a groove that extends around the stem and the cavity has a groove that extends around the wall of the cavity. A ball bearing ring is received within the groove of the cavity and the groove of the stem to rotatably connect the head to the holder.

### BACKGROUND OF THE INVENTION

This invention is related to a punch, and more particularly to an improved punch with a rotating head.

Punches with rotating heads are known in the art. As an example, the head is connected to a holder by two spring pins that allow rotation of the head in relation to the holder. While useful, these punches are difficult to assemble and, because of wear on the spring pins, the punches have a limited useful life. Therefore, a need exists in the art for a punch that addresses these deficiencies.

Accordingly, an objective of the present invention is to provide a punch that is easy to assemble.

A further objective of the present invention is to provide a punch that has a greater useful life.

These and other objectives will be apparent to one of ordinary skill in the art based upon the following written description, drawings, and claims.

### SUMMARY OF THE INVENTION

A punch having a head with a top section, middle section, and stem is rotatably connected to a holder. The holder has a cavity at one end with a groove that receives a ball bearing ring. The stem has a groove that when inserted within the cavity receives the ball bearing ring such that the head is rotatably connected to the holder.

### BRIEF DESCRIPTION OF THE DRAWINGS

FIG. 1 is a side sectional view of a punch;

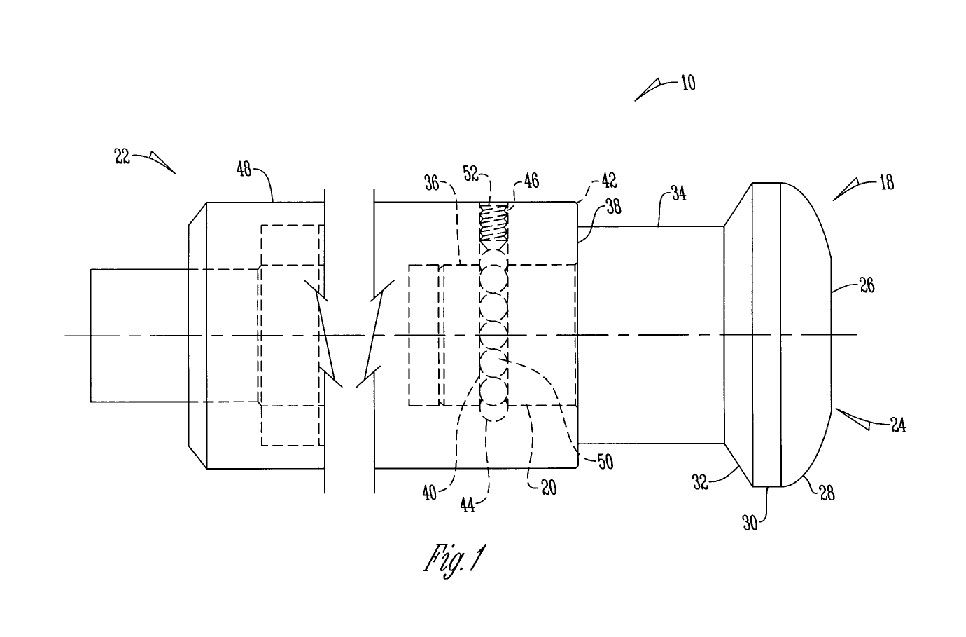

FIG. 2 is an exploded perspective view of a punch; and

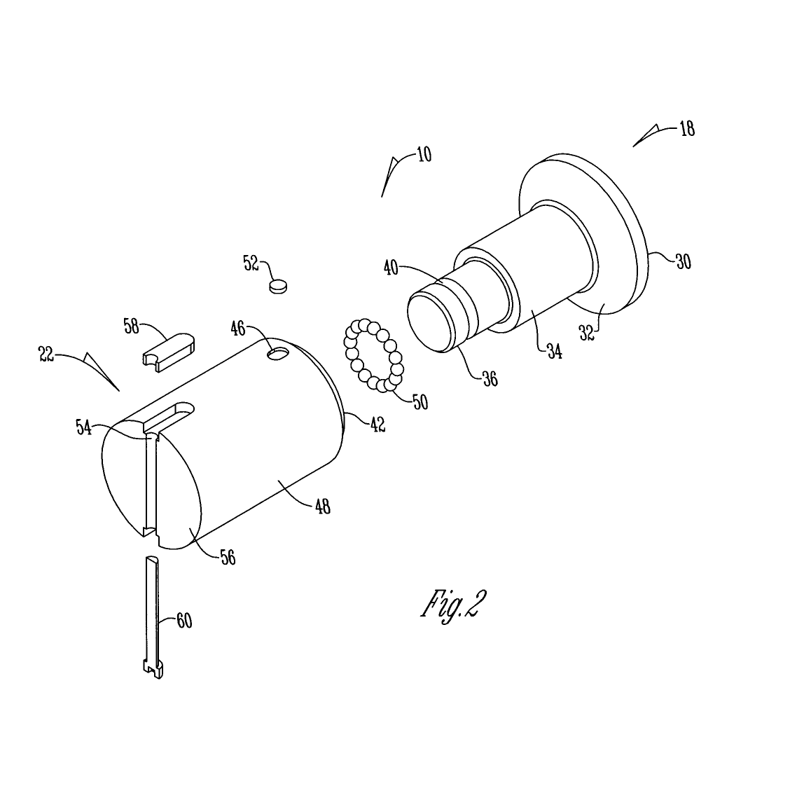

FIG. 3 is a side view of a head of a punch.

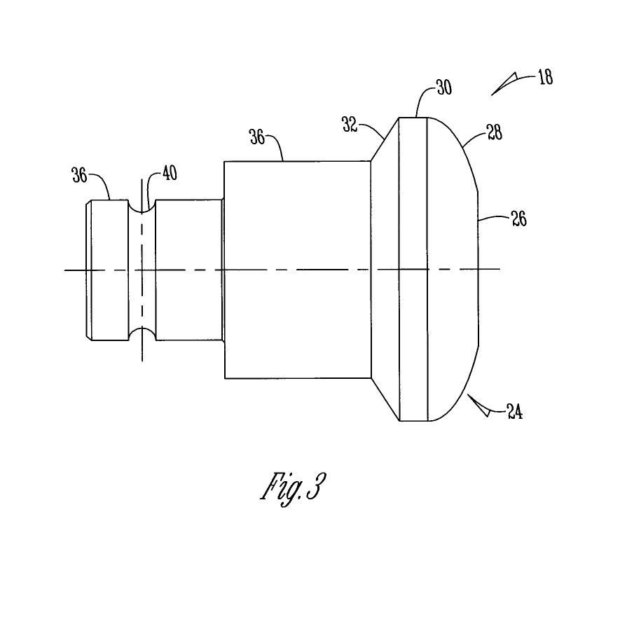

### DETAILED DESCRIPTION OF THE PREFERRED EMBODIMENTS

Referring to the Figures, the punch 10 has a rotating head 18 that fits within a central cavity 20 of a holder 22.

The head 18 has a top section 24 having a central flat surface 26 that terminates in a generally outwardly extending tapered surface 28. The tapered surface 28 terminates in a side edge 30 which terminates in an inwardly extending tapered surface 32. The inwardly extending tapered surface 32 terminates in a middle section 34 of head 18.

The middle section 34 of the head 18 is cylindrical and generally uniform in shape. Extending outwardly from the middle section 34 of head 18 is a third section or stem 36. The stem 36 has a diameter smaller than the diameter of the middle section 34 and forms a shoulder 38 therebetween. The stem 36 is cylindrical in shape and is generally uniform with the exception of a groove 40 that extends around stem 36.

The holder 22 is generally cylindrical in shape. At a first end 42 is cavity 20 which is generally cylindrical in shape with the exception of groove 44 which extends into the holder 22 from the cavity 20. An opening 46 extends from the outer surface 48 of the holder 22 to groove 44. The groove 44 is formed to receive a ball bearing ring 50 and the opening 46 is formed to receive a set screw 52.

In a preferred embodiment a key slot 54 is formed in the second end 56. The slot 54 receives a key 58 and screw 60.

To assemble, the ball bearing ring is inserted into groove 44 of cavity 20. Once inserted the stem 36 of the head 18 is inserted into cavity 20 such that shoulder 38 abuts first end 42 and the ball bearing ring 50 is received in groove 40 of stem 50. Next, set screw 52 is inserted into opening 46 and is rotated to exert sufficient force to hold the head 18 and holder 22 together while permitting the head 18 to rotate in relation to the holder 22.

What is claimed is:

1. A punch, comprising:
a head having a stem with a groove that extends around the stem;
a holder having a cavity with a groove that extends around the wall of the cavity; and
a ball bearing ring that is received within the groove of the holder and the groove of the stem to rotatably connect the head to the holder.

2. The punch of claim 1 further comprising an opening that extends from an outer surface of the holder to the groove of the cavity which receives a set screw.

3. The punch of claim 1 wherein the stem extends outwardly from a middle section of the head, and the middle section extends outwardly from a top section of the head.

4. The punch of claim 3 wherein the diameter of the stem is less than the diameter of the middle section to form a shoulder that abuts the first end of the holder.

5. The punch of claim 3 wherein the top section has a flat surface that terminates in an outwardly extending tapered surface.
